(19) United States
(12) Patent Application Publication
(10) Pub. No.: US 2025/0025808 A1
(43) Pub. Date: Jan. 23, 2025

(54) Low Evaporation Water Purifier

(71) Applicant: Chong Lee Loh, Johor Bahru (MY)

(72) Inventor: Chong Lee Loh, Johor Bahru (MY)

(21) Appl. No.: 18/830,385

(22) Filed: Sep. 10, 2024

Related U.S. Application Data
(60) Provisional application No. 63/512,848, filed on Jul. 10, 2023.

(51) Int. Cl. B01D 3/10; B01D 3/42; B01D 5/00; C02F 1/04; C02F 1/32; C02F 1/68; C02F 9/00

(52) U.S. Cl. CPC B01D 3/10; B01D 3/42; B01D 5/0006; B01D 5/006; C02F 9/00; C02F 1/048; C02F 1/32; C02F 1/68; C02F 2201/005; C02F 2209/02; C02F 2209/03; C02F 2209/42; C02F 2303/04; C02F 2307/06

(57) ABSTRACT

A water purification system designed to simulate the hydrological cycle for water purification. The water purification system comprises several main components and follows a series of steps to achieve efficient and effective water purification. The present invention comprises a vacuum chamber, a vacuum pump, a compressor, and a cooling coil. The vacuum chamber serves as the central unit where the water undergoes the simulated evaporation process. The vacuum pump creates a vacuum within the chamber, achieving an optimal vacuum range of 80%-92%, which lowers the boiling point of the water to 38-55° C. The compressor, utilizing its heat, transfers energy to the water in the vacuum chamber, leading to the generation of steam through a distillation process. The cooling coil, located after the distillation stage, condenses the steam back into liquid form, resulting in purified water collection. This condensed water, akin to rainwater, is clean and suitable for drinking.

### FIELD OF THE INVENTION

The present invention relates generally to a system for water purification. More specifically, the present invention is a system that simulates the hydrological cycle of water to purify water at temperatures lower than that of water at room temperature.

### BACKGROUND OF THE INVENTION

Water purification is a vital process that plays a crucial role in ensuring the availability of clean and safe drinking water. However, conventional methods of water purification are often associated with certain limitations and pitfalls. These methods typically include filtration, chemical treatment, and distillation, each with its own set of challenges.

Filtration methods, such as activated carbon filters or membrane filtration, effectively remove particulate matter and some contaminants from water. However, they may not be capable of eliminating certain dissolved impurities, including heavy metals and chemicals, which can pose significant health risks. Moreover, the filtration process requires regular maintenance and replacement of filters, making it costly and time-consuming.

Chemical treatment, such as chlorination, is commonly employed to disinfect water and eliminate harmful microorganisms. While this method is effective in killing bacteria and viruses, it may not completely remove chemical contaminants. Furthermore, the taste and odor of chemically treated water may be unappealing to consumers. Additionally, the use of chemicals introduces its own set of environmental concerns.

Distillation is another common method of water purification, which involves heating water to its boiling point to produce steam and then condensing it to obtain purified water. Although distillation can effectively remove various impurities, it requires substantial amounts of energy to heat the water to high temperatures, typically above 100° C. This energy-intensive process results in significant evaporation losses, leading to inefficient water utilization and increased costs.

The present invention aims to overcome these limitations and provide an innovative solution for water purification. An objective of the present invention is to provide a low evaporation water purifier that utilizes a vacuum chamber to simulate the natural hydrological cycle and achieve efficient purification.

The system comprises several key components to carry out this objective. Firstly, a vacuum chamber is integrated into the purifier, which allows the water to undergo a simulated evaporation process at temperatures below 100° C. This significantly reduces energy consumption compared to traditional distillation methods.

Secondly, a vacuum pump is employed to create a vacuum within the chamber, reaching an optimal range of 80%-92% vacuum. This lower pressure environment decreases the boiling point of the water, enabling it to evaporate at temperatures between 38-55° C. By utilizing the compressor's heat, which is transferred to the water in the vacuum chamber, steam is generated through a distillation process.

Lastly, a cooling coil is incorporated into the system to condense the steam, converting it back into liquid form. This condensed water, known as “rain” water, is then collected as purified water suitable for drinking. By mimicking the natural hydrological cycle, the low evaporation water purifier ensures efficient utilization of water and minimizes evaporation losses.

The low evaporation water purifier offers several advantages over conventional water purification methods. Firstly, it achieves efficient purification by significantly reducing energy consumption through the use of lower temperatures. The system minimizes evaporation losses and optimizes water utilization, making it environmentally friendly and cost-effective. Additionally, the low evaporation water purifier addresses the limitations of existing purification methods. It effectively removes a wide range of contaminants, including dissolved impurities, heavy metals, and chemicals. The simulation of the hydrological cycle ensures thorough purification, delivering clean and safe drinking water.

### SUMMARY OF THE INVENTION

The low evaporation water purifier is a system designed to simulate the hydrological cycle for water purification. It comprises several main components and follows a series of steps to achieve efficient and effective water purification. The present invention comprises a vacuum chamber, a vacuum pump, a compressor, and a cooling coil. The vacuum chamber serves as the central unit where the water undergoes the simulated evaporation process. The vacuum pump creates a vacuum within the chamber, achieving an optimal vacuum range of 80%-92%, which lowers the boiling point of the water to 38-55° C. The compressor, utilizing its heat, transfers energy to the water in the vacuum chamber, leading to the generation of steam through a distillation process. The cooling coil, located after the distillation stage, plays a vital role in condensing the steam back into liquid form, resulting in purified water collection. This condensed water, akin to rainwater, is clean and suitable for drinking.

The functionality of the low evaporation water purifier relies on the simulation of the hydrological cycle within the vacuum chamber. By creating a controlled environment of reduced pressure and lower boiling points, the system effectively replicates the natural process of evaporation, condensation, and precipitation.

The steps involved in the water purification process of the low evaporation water purifier are water intake, vacuum creation, evaporation and distillation, condensation, and collection. Water from a source, such as a tap or a reservoir, is piped into the vacuum chamber of the purifier. The vacuum pump is activated, removing air from the vacuum chamber and creating a reduced-pressure environment. The vacuum level is carefully controlled within the optimal range of 80%-92%, which lowers the boiling point of the water inside the chamber. As the water is subjected to the reduced pressure and lower boiling point, the compressor's heat is transferred to the water, initiating the evaporation process. The water molecules absorb energy and convert into steam. The distillation process separates the contaminants and impurities from the water, leaving them behind in the chamber. After the distillation process, the generated steam passes through a cooling coil. The cooling coil is responsible for reducing the temperature of the steam, causing it to condense and convert back into liquid form. This condensed water is collected as purified water. The condensed water, resembling rainwater in its purity, is collected in a separate container or storage unit within the purifier. This purified water is now suitable for drinking, free from various impurities and contaminants that were present in the source water.

### BRIEF DESCRIPTION OF THE DRAWINGS

FIG. 1 is a system diagram of the present invention.

FIG. 2 is a flow diagram of the present invention.

FIG. 3 is diagrams of the cold tank and hot tank of the present invention.

FIG. 4 is a diagram of the CC unit of the present invention.

FIG. 5 is an CPU diagram of the present invention.

FIG. 6 is a GUI showing the maintenance screen of the present invention.

FIG. 7 is a flow diagram of the purification process of the present invention.

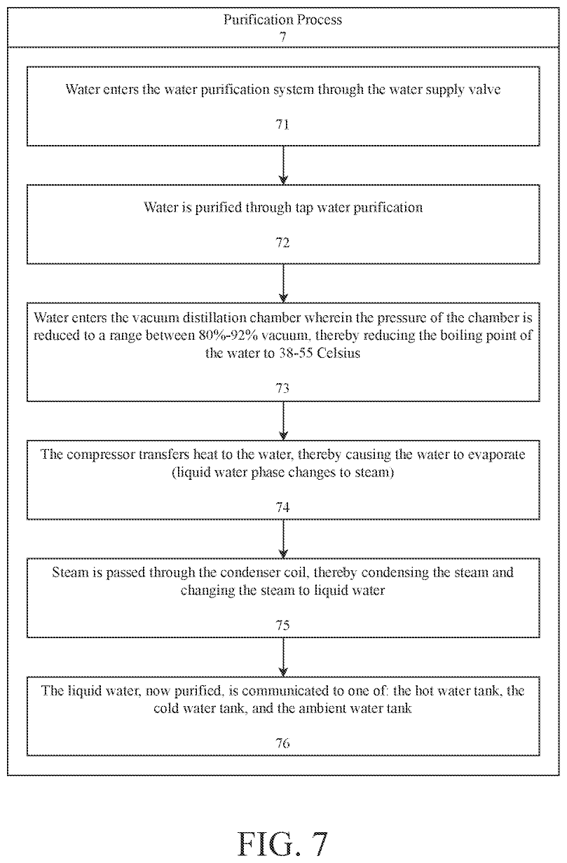

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a low evaporation water purifier, embodiments of the present disclosure are not limited to use only in this context.

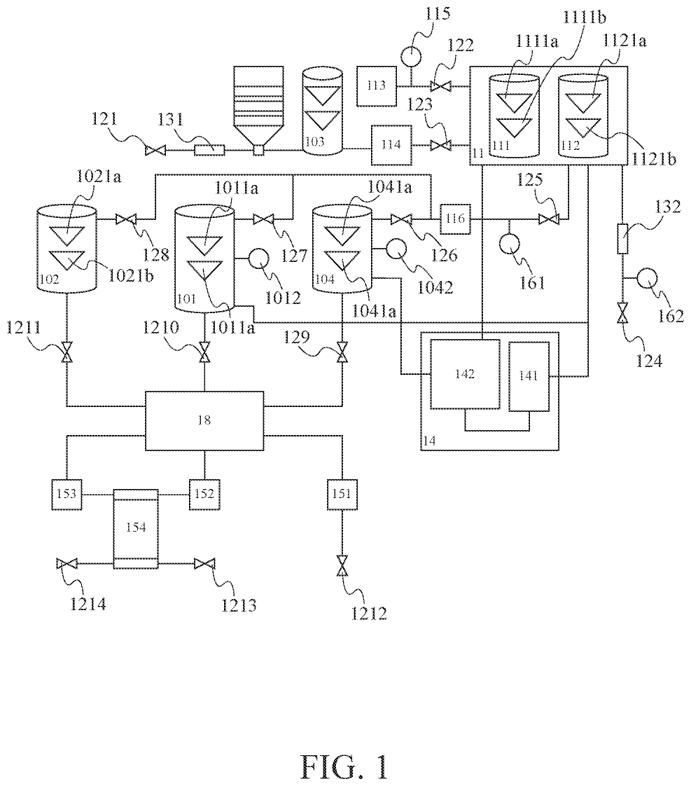

The present invention is a water purification device 1, as shown in FIGS. 1-6, wherein said FIGS. 1-6 are used herein to describe said invention. It is necessary to understand that the present invention pertains to a water purification system 1 and it not to be misconstrued, limited, or interpreted as a water filtration device. A water purification device, which the present invention is not, is referred to herein as a device that utilizes a filter wherein a filter defined as a device or apparatus having a permeable material that removes impurities from a liquid as said liquid passes through the material. Moreover, a filter is an apparatus that absorbs the impurities or contaminants within the permeable material. Furthermore, the term “low evaporation” is in regard to the low temperature evaporation that the present invention is able to carry out due to a reduction in pressure within the system.

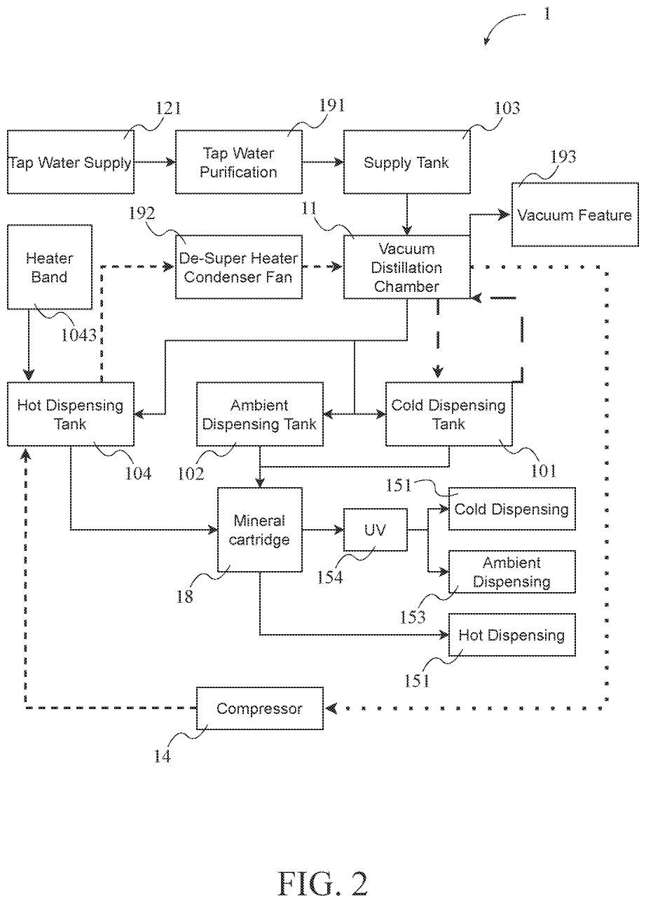

The present invention, as shown in FIG. 1 and FIG. 2 is a water purification system 1 comprising an intake 121 from a water source. In the preferred embodiments of the present invention the water source is a tap water supply 121. The present invention comprises a plurality of tanks including a cold tank 101, an ambient tank 102, a storage tank 103, and a hot tank 104. In the preferred embodiment of the present invention, the cold tank 101 is a 7-liter insulated container. Further, in the preferred embodiment of the present invention, the ambient tank 102 is a 1800-millileter storage container. Additionally, in the preferred embodiment of the present invention, the storage tank 103 is a 1800-milliliter storage container. Furthermore, in the preferred embodiment of the present invention, the hot tank 104 is a stainless steel sterilized container. Although the cold tank 101, the ambient tank 102, the storage tank 103, and the hot tank 104 have been described as a having a preferred embodiment, the aforementioned tanks are not to be interpreted to only having the limitations as previously stated, however the aforementioned tanks may comprise of any embodiment of container that may hold a fluid. In the context of the present invention, the cold water tank 101, the ambient water tank 102, and hot water tank 104 are denoted by the temperature of the water contained within each of the aforementioned water tanks wherein the temperature of water contained within the hot water tank 104 is greater than the water contained within the cold water tank 101, and the water contained within the ambient water tank 102 is maintained at a temperature between the temperature of the water contained within the cold water tank 101 and the temperature of the water contained within the hot water tank 104.

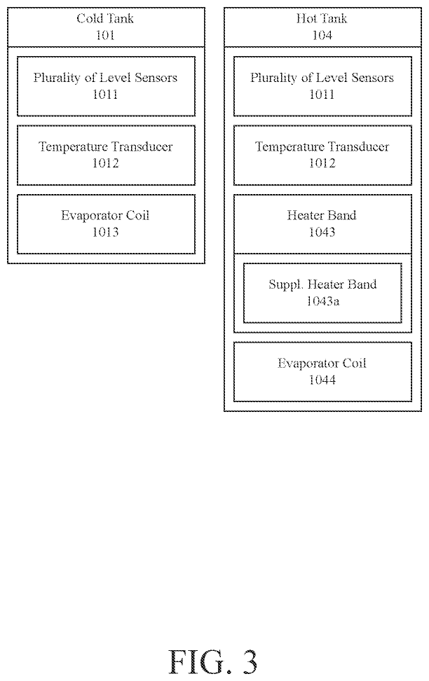

Furthermore, as shown in FIG. 1 and FIG. 3, in the preferred embodiment of the present invention, each of the cold water tank 101, the ambient water tank 102, the storage tank 103, and the hot water tank 104, each comprise a plurality of level sensors. In the context of the present invention, the plurality of level sensors, as understood to those within the art, are devices that measure the fluid level within a container. Furthermore, the cold water tank 101, also referred to herein as the cold tank 101, comprises a plurality of level sensors including a high level sensor 1011a and a low level sensor 1011b. Likewise, in the preferred embodiment of the present invention, the ambient tank 102 comprises a high level sensor 1021a and a low level sensor 1021b; the storage tank 103 comprises a high level sensor 1031a and a low level sensor 1031b; and the hot tank 104 comprises a high level sensor 1041a and a low level sensor 1041b. In the context of the present invention, the high level sensors are maintained at an elevation above the low level sensors. Further, the level sensors 1011 contained within the cold tank 101, in the preferred embodiment is a 150 mm length double float sensor. In the preferred embodiment of the present invention, the level sensor 1041 within the hot tank 104 is a 100 mm length double float sensor. Additionally, in the preferred embodiment of the present invention, the level sensors 1021,1031 contained within the ambient tank 102 and the storage tank 103 are 200 mm length double float sensors.

In the preferred embodiment of the present invention, as shown in FIG. 3, the hot water tank 104 comprises a heating band 1043 wherein the heating band 1043 increases the temperature of the fluid within the hot water tank 104. Additionally, in the preferred embodiment of the present invention, the hot water tank 104 further comprises a temperature transducer 1042, and an evaporator coil 1044. As shown in FIG. 3, the cold water tank 101 further comprises a temperature transducer 1012 and an evaporator coil 1013.

Additionally within the preferred embodiment, the present invention further comprises a vacuum chamber 11, a plurality of solenoid valves, a plurality of flow sensors 131,132, a condenser-compressor unit (CC unit) 14, a dispensing system 15, and a plurality of total dissolved solids (TDS) sensors. In some embodiments of the present invention, the water purification system 1 further comprises a tap water purification system 191, a de-super heater condenser fan 192, and a vacuum feature 193.

In the preferred embodiment of the present invention, the vacuum chamber 11, as shown in FIG. 1, comprises a condensate tank 111 and an evaporator tank 112. In the preferred embodiment of the present invention, the condensate tank 111 comprises a plurality of level sensors 1111 including a high level sensor 1111a and a low level sensor 1111b. Additionally, the evaporator tank 112 comprises a plurality of level sensors 1121 including a high level sensor 1121a and a low level sensor 1121b. Furthermore, in the preferred embodiment of the present invention a vacuum pump 113 is coupled to the vacuum chamber 11 through a section of tubing whereby the vacuum pump 113 reduces the pressure of the vacuum chamber 11. In the preferred embodiment of the present invention, the pressure of the vacuum chamber 11 is reduced to at least a partial vacuum chamber 11. In the preferred embodiment of the present invention, the vacuum distillation chamber 11 is a chamber comprising a pressure that is at least 82% vacuum. In the preferred embodiment, the vacuum distillation chamber 11 is between 82% and 92% vacuum. Within the preferred embodiment of the present invention, at such pressure conditions, the boiling point of water is lowered to a range between 38° C. and 55° C. In the aforementioned embodiment, the utilization of at least partial vacuum conditions allows for the system to utilize less energy in increasing the temperature of the water. Additionally, in the preferred embodiment of the present invention, the water purification system 1 further comprises a feed pump 114. In the context of the present invention, the feed pump 114 communicated water from the storage tank 103 into the vacuum chamber 11, through a section of tubing. Moreover, in the preferred embodiment of the present invention, the water purification system 1 further comprises a transfer pump 116 wherein said transfer pump 116 draws water from the evaporation chamber 11.

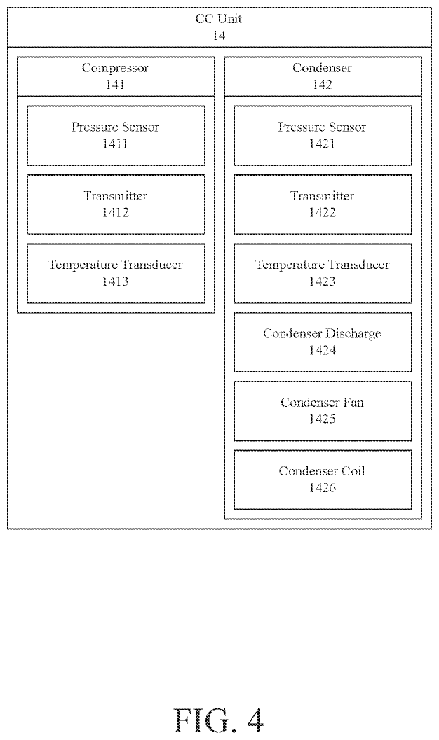

In the preferred embodiment of the present invention, the CC unit 14 comprises a compressor 141 and a condenser 142. As shown in FIG. 4, in the preferred embodiment of the present invention, the compressor 141 comprises a pressure sensor 1411, a transmitter 1412 and a temperature transducer 1413. In the context of the present invention the compressor 141 increases the pressure of a gas refrigerant, wherein upon being pressurized, said gas is forced through the condenser 142. Furthermore, in the preferred embodiment of the present invention, the condenser 142 comprises a pressure sensor 1421, a transmitter 1422, a temperature transducer 1423, a condenser discharge 1424, a condenser fan 1425, and a condenser coil 1426. In the context of the present invention, the condenser 142 cools and condenses the pressurized gas refrigerant into a liquid refrigerant through the condenser coil 1426. Further, within the context of the present invention the condenser fan 1425 moves air across the condenser coil 1426, thereby dissipating heat from the system.

Furthermore, the dispensing system of the present invention comprises a hot water dispensing pump 151, a cold water dispensing pump 152, and an ambient water dispensing pump 153. In some embodiments of the present invention, the water purification system 1 further comprises a UV light 154. In the context of the present invention, exposure to the UV light 154 disinfects the water. Additionally, in some embodiments of the present invention, the water purification system 1 further comprises a mineral cartridge 18 wherein minerals are added into the water.

In the preferred embodiment of the present invention, the present invention further comprises a plurality of sensors including a plurality of flow sensors 131,132, a plurality of pressure sensors, a vacuum pressure transducer, a plurality of solenoid valves, a plurality of temperature transducers, and the plurality of TDS sensors. In the preferred embodiment of the present invention, the plurality of flow sensors, a first flow sensor 131 and a second flow sensor 132, wherein said flow sensors are known in the art as devices to measure and regulate flow rate of fluids though pipes.

In the preferred embodiment of the present invention, the plurality of pressure sensors, a first pressure sensor and a second pressure sensor, further comprises a transmitter. Additionally, within the preferred embodiment of the present invention, the vacuum pressure transducer 115 is a device that converts pressure or vacuum into an electrical signal. Further, the plurality of temperature transducers comprises a plurality of 30 mm temperature transducers, a first 30 mm temperature transducer 1042 and a second 30 mm temperature transducer 1012, a 100 mm temperature transducer, a first 200 mm temperature transducer, and a second 200 mm temperature transducer.

In the preferred embodiment, the present invention further comprises a refrigerator compressor filter dryer and an at least one heater band 1043. In the preferred embodiment of the present invention, the at least one heater band comprises a main heater band 1043 and in some embodiments of the present invention, the present invention comprises a spare heater band 1043a.

In the preferred embodiment, the present invention further comprises a plurality of solenoid valves wherein said plurality of solenoid valves comprises a water supply valve 121, a vacuum pump valve 122, a tap pump valve 123, a drain valve 124, an output pump valve 125, a hot water tank intake valve 126, a cold water tank intake valve 127, an ambient water tank intake valve 128, a hot water tank release valve 129, a cold water tank release valve 1210, an ambient water tank release valve 1211, a hot water dispensing valve 1212, a cold water dispensing valve 1213, and an ambient water dispensing valve 1214. In the preferred embodiment of the present invention, the water supply valve 121 facilitates and controls the flow of water into the water purification system 1 from an external water source. In the context of the present invention, the vacuum pump valve 122 is interposed between the vacuum pump 113 and the vacuum chamber 11, whereby the interposed vacuum pump valve 122 facilitates and controls, through a section of tubing, the communication between the vacuum pump 113 and the vacuum chamber 11. In the context of the present invention, the tap pump valve 123 is interposed between the feed pump 114 and the vacuum chamber 11, wherein said tap pump valve 123 facilitates and controls the flow of water from the feed pump 114 to the vacuum chamber 11, through said tap pump valve 123 and a section of tubing. Furthermore, within the context of the present invention, the drain valve 124 facilitates and controls the release of water from the system, whereby the drain valve 124 controllably releases water from the vacuum chamber 11. Further, in the preferred embodiment of the present invention, the output pump valve 125 is interposed between the vacuum chamber 11 and the transfer pump 116, wherein the output pump valve 125 is coupled to a section of tubing, said output pump valve 125 facilitating and controlling the flow of water from the vacuum chamber 11 to the transfer pump 116. Additionally, the hot water tank intake valve 126 controls and facilitates the flow of water into the hot water tank 104. Likewise, in the preferred embodiment of the present invention, the cold water tank intake valve 127 controls and facilitates the flow of water into the cold water tank 101. Moreover, the ambient water tank intake valve 128 controls and facilitates the flow of water into the ambient water tank 102. Additionally, the hot water tank release valve 129 controls and facilitates the flow of water from the hot water tank 104. Likewise, in the preferred embodiment of the present invention, the cold water tank release valve 1210 controls and facilitates the flow of water from the cold water tank 101. Moreover, the ambient water tank release valve 1211 controls and facilitates the flow of water from the ambient water tank 102. In the preferred embodiment of the present invention, the hot water dispensing valve 1212, the cold water dispensing valve 1213, and the ambient water dispensing valve 1214 each release water from the system.

As shown in FIG. 1, in the preferred embodiment of the present invention, the first flow sensor 131 is interposed between the water supply valve 121 and the storage water tank 103 wherein the first flow sensor 131 monitors and communicates to the user signals representative of the quantity of water entering the water purification system 1 through the water supply valve 121. Furthermore, within the context of the present invention, the second flow sensor 132 is adjacent to the drain valve 124, whereby the second flow sensor 132 monitors and communicates to the user signals representative of the quantity of water dispensed from the system through the drain valve 124.

In the preferred embodiment of the present invention, water enters through the water supply valve 121, and traverses through a section of tubing and the flow sensor 131 into a tap water purification system 1. In the context of the present invention, the water entering into the system is considered dirty water. Dirty water within the context of the present invention is water that has not yet been purified. In the context of the present invention, water is communicated from the water supply valve 121 to the storage water tank 103. The plurality of level sensors 1031 within the storage water tank 103, indicate the fluid level of water within said storage tank 103. In the preferred embodiment of the present invention, water is communicated from the storage water tank 103 to the vacuum chamber 11, whereby the feed pump 114 facilitates the communication of water from the storage water tank 103 to the vacuum chamber 11. Further, upon entering the vacuum chamber 11, the water is communicated into the condensate tank 111 and the evaporator tank 112, wherein the condensate tank 111 and the evaporator tank fill 112, at least partially with water, wherein a plurality of level sensors 1111,1121 communicates signals to the user to indicate the level of water within the evaporator tank 112 and the condensate tank 111. More specifically, in the preferred embodiment of the present invention, the condensate tank comprises a high level sensor 1111a and a low level sensor 1111b, and the evaporator tank 112 comprises a high level sensor 1121a and a low level sensor 1121b.

Furthermore, in the context of the present invention, the vacuum pump 113 reduces the pressure of the vacuum chamber, thereby producing at least a partial vacuum. In the preferred embodiment of the present invention, a vacuum transducer 115, to the user, signals indicative of the pressure within the vacuum chamber. The vacuum distillation chamber is a chamber comprising a pressure that is at least 82% vacuum. In the preferred embodiment, the vacuum distillation chamber is between 82% and 92% vacuum. Within the preferred embodiment of the present invention, the boiling point of water is lowered to a range between 38° C. and 55° C.

Water, is then communicated from the vacuum chamber 11 to the transfer pump 116, wherein the water is then communicated, through a section of tubing, to each of: the hot water tank 104, the cold water tank 101, and the ambient water tank 102. Alternatively, in some embodiments of the present invention, the water is discharges through the drain valve 124, upon exiting the vacuum chamber. In the preferred embodiment, from each of the water tanks 101,102,104, in some embodiments, water is then communicated to a mineral cartridge 18. In some embodiments of the present invention, water is communicated from each of the hot water tank 104, the cold water tank 101, and the ambient water tank 102, through the respective dispenser pumps 151,152,153, and out of the system through respective dispenser valves 1212,1213,1214. In the preferred embodiment of the present invention, the water is communicated from the cold water tank 101 and the ambient water tank 102, through the UV light 154 prior to being dispensed from the system 1 through the respective dispensing valves 1213,1214.

In the preferred embodiment of the present invention, extending from the vacuum distillation chamber 11 is a section of tubing that is attached to the compressor and condenser unit 14 wherein said section of tubing comprises a pressure sensor and a temperature sensor. Furthermore, the vacuum distillation chamber 11 comprises a section of tubing that facilitates communication of refrigerant between the vacuum distillation chamber 11 and the cold dispensing tank 101.

Further, in the preferred embodiment of the present invention, the present invention comprises a refrigerant cycle. In the preferred embodiment of the present invention, high pressure liquid refrigerant flows from the vacuum distillation chamber 11 into the cold dispensing tank 101. In the previously mentioned embodiment, a low pressure vapor and liquid mixture of refrigerant is communicated from the cold dispensing tank 101 to the vacuum distillation chamber 11. Further, in the preferred embodiment of the present invention, a low pressure vapor refrigerant is communicated through a section of tubing comprising a temperature sensor and a pressure sensor to the compressor from the vacuum distillation chamber 11. In the preferred embodiment of the present invention, high pressure vapor refrigerant is communicated from the compressor to the hot dispensing tank and into the vacuum distillation chamber 11 through a section of copper tubing wherein said section of copper tubing comprises the copper coil and the de-super heater condenser fan 192. Furthermore, the section of copper tubing comprising the copper coil further comprises a temperature sensor and a pressure sensor.

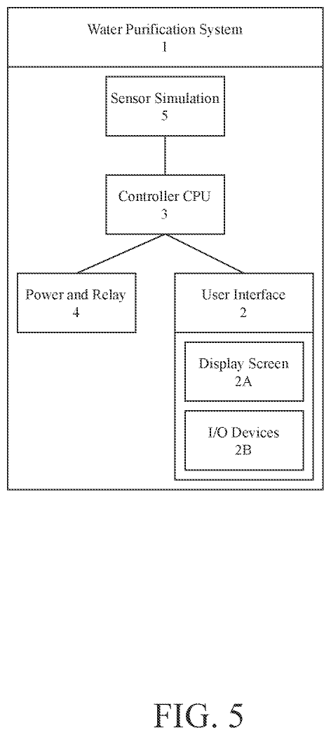

Additionally, the water purification system further comprises a controller 3 wherein said controller 3 comprises a processing unit 3, as shown in FIG. 5. The processing unit 3 allows for the operation, control, and functionality of the components within the water purification system 1. The present invention further comprises a sensor simulation system 5, a power and relay system 4, and a user interface 2, wherein the user interface 2 comprises a display screen 2a and an at least one I/O device 2b. The sensor simulation system 5, the power and relay system 3, and the user interface 2 are connected to the processing unit 3. The user interface 3 is a device communicating information to and from a user and the water purification system 1.

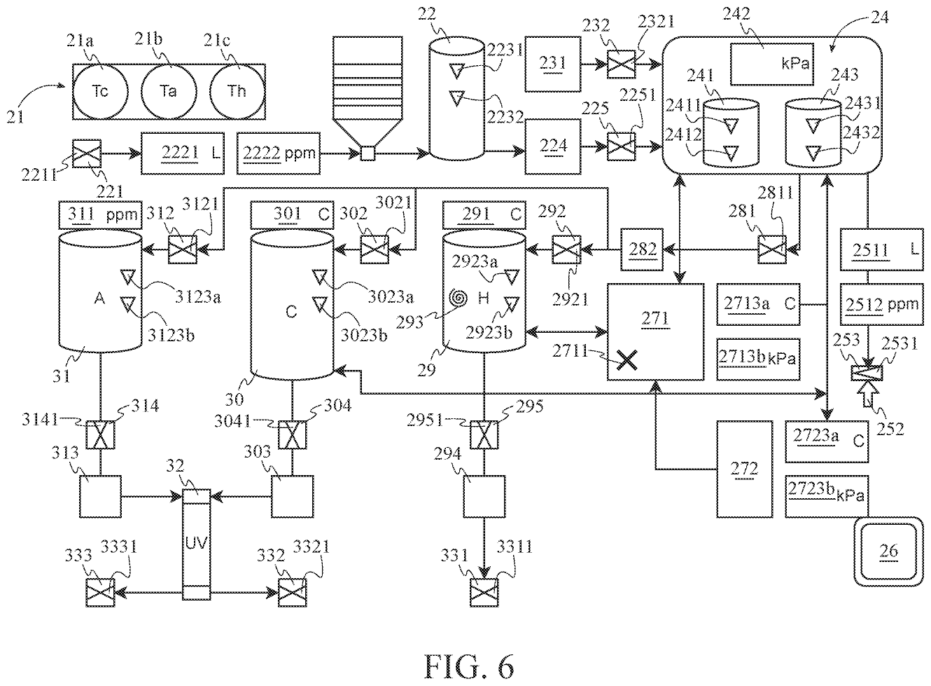

In the preferred embodiment of the present invention, as shown in FIG. 5, the user interface 2 comprises a dashboard comprising a cold water dispense button 21a, an ambient water dispense button 21b, a hot water dispense button 21c, and a hidden button to switch to a maintenance screen. In the preferred embodiment, user interface, as shown in FIG. 5 and FIG. 6, is a GUI screen displaying a digital representation of the system, capable of providing feedback and allowing user input. More specifically, in the preferred embodiment of the present invention, the user interface comprises a plurality of interfaces wherein said interfaces are corresponsive to components of the physical system of the water purification system 1.

In the preferred embodiment of the present invention, the user interface comprises a plurality of dispenser buttons 21, a tap system control interface 22, a vacuum pump system control interface 23, an evaporator-vacuum chamber-condensate (EVC) system control interface 24, a drain valve system control interface 25, a manual toggle 26, a compressor-condenser system control interface 27, an output water system control interface 28, a hot water system control interface 29, a cold water system control interface 30, an ambient water system control interface 31, a UV light system control interface 32, and a plurality of dispenser release valve system control interfaces 33. In the context of the present invention, the manual toggle 26 allows a user to adjustably switch from making manual inputs into the system 1 to making inputs through the user interface 2.

In the preferred embodiment of the present invention, the plurality of dispenser buttons 21 comprises a cold button 21a, an ambient button 21b, and a hot button 21c. In the context of the present invention, the cold button 21a converts an input from the user to dispense water from the cold water tank 101. Likewise, in the context of the present invention, the ambient button 21b converts an input from the user to dispense water from the ambient water tank 102. Further, in the context of the present invention, the hot button 21c converts an input from the user to dispense water from the hot water tank 104.

In the preferred embodiment of the present invention, the tap system control interface 22 comprises a tap valve control 221, a tap display control 222, a plurality of tap level indicators 223, a tap pump control 224, and a tap pump valve control 225. In the context of the present invention, the tap valve control 221 controls the water supply valve 121 through the tap valve icon 2211. Similarly, the tap display control 222 comprises a volume display 2221 and a water total dissolved solids display 2222. Furthermore, in the context of the present invention, the plurality of tap level indicators 223 comprising a high level indicator icon 2231 and a low level indicator 2232. In the context of the present invention, the plurality of tap level indicators 223 facilitate control and feedback from the high level sensor 1031a and low level sensor 1031b of the storage tank 103. Additionally, in the preferred embodiment of the present invention, the tap pump control 224 facilitates input and feedback from the feed pump 114. In the preferred embodiment of the present invention, the tap pump valve control 225 facilitates input and feedback from the tap pump valve 123 through the respective icon 2251. In the context of the present invention, to “facilitate control and feedback” and to “facilitate input and feedback” is defined as allowing a user to provide input into the system to manipulate variables on the system and display feedback from the system.

In the preferred embodiment of the present invention, the vacuum pump system control interface 23 comprises a vacuum pump control 231 and a vacuum pump valve control 232. In the context of the present invention, the vacuum pump control 231 facilitates input and feedback of the vacuum pump 113. Furthermore, in the preferred embodiment of the present invention, the vacuum pump valve control 2321 facilitates input and feedback of the vacuum pump valve 122 through the respective icon 2321.

In the preferred embodiment of the present invention, the EVC system control interface 24 comprises a plurality of evaporator tank indicators 241 comprising a high level indicator 2411 and a low level indicator 2412 wherein said indicators facilitate control and feedback of the high level sensor 1121a and low level sensor 1121b within the evaporator tank 112. Further, in the preferred embodiment of the present invention, the EVC system control interface 24 further comprises a vacuum chamber display 242 wherein said display provides feedback pertaining to the vacuum chamber 11. Furthermore, the EVC system control interface 24 comprises a plurality of condensate tank indicators 243 comprising a high level indicator 2431 and a low level indicator 2432 wherein said indicators facilitate control and feedback of the high level sensor 1111a and low level sensor 1111b within the condensate tank 111.

In the preferred embodiment of the present invention, the drain valve control system interface 25 comprises a drain display control 251, a drain control 252, and a drain valve control 253. In the preferred embodiment of the present invention, the drain display control comprises a drain volume display 2511 and a drain TDS display 2512. In the preferred embodiment of the present invention, the drain control 252 and drain valve control 253 facilitate control and provide feedback pertaining to the drain valve 124 through the respective icon 2531.

In the preferred embodiment of the present invention, the CC system control interface comprises 27 a condenser unit control 271 and a compressor unit control 272. In the preferred embodiment of the present invention, the condenser unit control 271 further comprises a condenser fan control 2711 and a liquid refrigerant display 2713. In the context of the present invention, the condenser fan control 2711 facilitates input and provides feedback of the condenser fan 1425 within the system 1. Additionally, the liquid refrigerant display 2713 provides feedback and facilitates control of a liquid refrigerant temperature 2713a and a liquid refrigerant pressure 2713b. Furthermore, in the preferred embodiment of the present invention, the compressor unit control 272 comprises a gas refrigerant display 2723 wherein said gas refrigerant display provides feedback to a user pertaining to a gas refrigerant temperature 2723a and a gas refrigerant pressure 2723b.

In the preferred embodiment of the present invention, the output water control interface 28 comprises an output water valve control 281 and an output water pump control 282. In the context of the present invention, the output water valve control 281 provides feedback and facilitates control of the output pump valve 125 though the output pump valve indicator 2811. Furthermore, in the context of the present invention, the output water pump control 282 facilitates control and provides feedback of the transfer pump 116 of the water purification system 1.

In the preferred embodiment of the present invention, the hot water system control interface 29 comprises a hot water temperature display 291, a hot water tank valve control 292, a heater control 293, a hot water dispense pump control 294, and a hot water dispenser pump valve control 295. In the context of the present invention, the hot water tank valve control 292 facilitates control and provides feedback pertaining to the hot water tank intake valve 126 through the hot water tank valve indicator 2921. Additionally, the hot water tank valve control 292 further comprises a plurality of hot water tank valve level indicators 2923 comprising a high level sensor 2923a and a low sensor 2923b wherein said plurality of hot water tank valve level indicators 2923 facilitates control and provides feedback pertaining to the high level sensor 1041a and the low level sensor 1041b contained within the hot water tank 104. In the context of the present invention, the heater control 293 facilitates control and provides feedback pertaining to the heater band 1043. In the context of the present invention, the hot water dispense pump control 294 facilitates control and provides feedback pertaining to the hot water dispense pump 151. Furthermore, in the context of the present invention, the hot water dispense pump valve control 295 facilitates control and provides feedback pertaining to the hot water tank release valve 129 through the hot water release valve indicator 2951.

In the preferred embodiment of the present invention, the cold water system control interface 30 comprises a cold water temperature display 301, a cold water tank valve control 302, a cold water dispense pump control 303, and a cold water dispenser pump valve control 304. In the context of the present invention, the cold water tank valve control 302 facilitates control and provides feedback pertaining to the cold water tank intake valve 127 through the respective indicator 3021. Additionally, the cold water tank valve control 302 further comprises a plurality of cold water tank valve level indicators 3023 comprising a high level 3023a and a low level 3023b indicator wherein said plurality of cold water tank valve level indicators 3023 facilitates control and provides feedback pertaining to the high level sensor 1011a and the low level sensor 1011b contained within the cold water tank 101. In the context of the present invention, the cold water dispense pump control 303 facilitates control and provides feedback pertaining to the cold water dispense pump 152. Furthermore, in the context of the present invention, the cold water dispense pump valve control 304 facilitates control and provides feedback pertaining to the cold water tank release valve 1210 through the respective indicator 3041.

In the preferred embodiment of the present invention, the ambient water system control interface 31 comprises a cold water TDS display 311, an ambient water tank valve control 312, an ambient water dispense pump control 313, and an ambient water dispenser pump valve control 314. In the context of the present invention, the ambient water tank valve control 312 facilitates control and provides feedback pertaining to the ambient water tank intake valve 128 through the ambient water tank intake valve indicator 3121. Additionally, the ambient water tank valve control 312 further comprises a plurality of ambient water tank valve level indicators 3123 comprising a high level 3123a and a low level 3123b indicator wherein said plurality of ambient water tank valve level indicators 3123 facilitates control and provides feedback pertaining to the high level sensor 1021a and the low level sensor 1021b contained within the ambient water tank 102. In the context of the present invention, the ambient water dispense pump control 313 facilitates control and provides feedback pertaining to the ambient water dispense pump 153. Furthermore, in the context of the present invention, the ambient water dispense pump valve control 314 facilitates control and provides feedback pertaining to the ambient water tank release valve 1211 through the ambient water tank release valve indicator 3141.

In the context of the present invention, the UV light system control interface 32 facilitates control and provides feedback of the UV light 154 of the water purification system 1. Additionally, in the context of the present invention, the plurality of dispenser release valve system control interface 33 comprises a hot water dispenser release valve control 331, a cold water dispenser release valve control 332, and an ambient water dispenser release valve control 333. In the context of the present invention, the hot water dispenser release valve control 331 facilitates control and provides feedback pertaining to the hot water dispensing valve 1212. In the context of the present invention, the cold water dispenser release valve control 332 facilitates control and provides feedback pertaining to the cold water dispensing valve 1213. In the context of the present invention, the ambient water dispenser release valve control 333 facilitates control and provides feedback pertaining to the ambient water dispensing valve 1214.

Additionally, the present invention further comprises a purification process 7 comprising a plurality of steps. In the preferred embodiment of the present invention, the purification process 7 comprises a first step wherein water enters 71 the water purification system 1 through the water supply valve 121. Furthermore, in the preferred embodiment of the present invention, the present invention comprises a second step wherein the water is purified 72 through tap water purification 191. Further, in the preferred embodiment of the present invention, the purification process 7 comprises a third step wherein the water enters the vacuum distillation chamber 11 wherein the pressure of the chamber 11 is reduced 73 to a range between 80%-92% vacuum, thereby reducing the boiling point of the water to 38-55° Celsius. In the preferred embodiment, the purification process 7 further comprises a fourth step wherein the compressor 14 transfers 74 heat to the water, boiling said water, thereby causing the water to evaporate (liquid water phase changes to steam) and transfer into the evaporation tank 112. In the preferred embodiment of the present invention, the purification process 7 further comprises a fifth step wherein the steam is passed through the condenser coil 1426, thereby condensing 75 the steam and changing the steam to liquid water. Furthermore, in the preferred embodiment of the present invention the purification process 7 further comprises a sixth step wherein the liquid water, now purified, is communicated 76 to one of: the hot water tank 104, the cold water tank 101, and the ambient water tank 103.

Although the invention has been explained in relation to its preferred embodiment, it is to be understood that many other possible modifications and variations can be made without departing from the spirit and scope of the invention.

What is claimed is:

1. A water purification system comprising:
a plurality of water tanks;
a vacuum chamber;
a condenser and compressor unit; and
a dispensing system;
wherein:
the plurality of water tanks contain a volume of water wherein said volume is monitored by a plurality of level sensors;
a feed pump forces water into the vacuum chamber from a water supply;
the condenser and compressor unit transfer heat throughout the system using refrigerant; and
the dispensing system expels water from at least one of the plurality of water tanks.

2. The water purification system as claimed in claim 1, wherein the vacuum chamber further comprises:
a vacuum pump;
an evaporation tank; and
a condensate tank;
wherein:
the vacuum pump reduces the pressure of the vacuum chamber; and
the evaporation tank and the condensate tank are housed within the vacuum chamber.

3. The water purification system as claimed in claim 2 wherein the condenser and compressor unit comprises:
a compressor; and
a condenser;
wherein:
the condenser comprises a condenser coil;
the compressor comprises a pressure sensor, a transmitter, and a temperature transducer; and
the compressor increases a pressure of a gas refrigerant, wherein upon being pressurized, said gas is forced through the condenser.

4. The water purification system as claimed in claim 3 wherein the condenser comprises:
a pressure sensor;
a transmitter;
a temperature transducer;
a condenser fan.

5. The water purification system as claimed in claim 3 wherein the plurality of water tanks comprises:
a hot water tank;
a cold water tank; and
an ambient water tank;
wherein:
the ambient water tank contains a volume of water comprising an ambient temperature;
the hot water tank comprises a volume of water comprising a temperature wherein the temperature of the volume of water contained within the hot water tank is greater than the temperature of the volume of water of the ambient tank; and
the cold water tank comprises a volume of water comprising a temperature wherein the temperature of the volume of water contained within the cold water tank is lower than the temperature of the volume of water of the ambient tank.

6. The water purification system as claimed in claim 5 further comprising:
a mineral cartridge;
wherein:
the mineral cartridge is interposed between the plurality of water tanks and the dispensing system;
the mineral cartridge adds minerals to water before dispensing water through the dispensing system.

7. The water purification system, as claimed in claim 5 further comprising a UV light wherein:
the UV light is interposed between both of the cold water tank and the ambient water tank, and the dispensing system;
the UV light sanitizes water before such water is expelled through the dispensing system.

8. The water purification system, as claimed in claim 7 further comprising a water supply valve wherein water enters into the water purification system.

9. The water purification system as claimed in claim 8 further comprising a tap water purification system wherein water traverses from the water supply valve to the tap water purification system.

10. The water purification system as claimed in claim 9 wherein the vacuum chamber, containing a volume of water, is reduced to a pressure of 80%-92% vacuum.

11. The water purification system as claimed in claim 10 wherein the compressor transfers heat to the water within the vacuum chamber, causing the water evaporate at a temperature between 38°-55° C., producing steam.

12. The water purification system as claimed in claim 11 wherein the condenser coil condenses the steam into liquid water.

13. The water purification system, as claimed in claim 12 wherein the plurality of tanks contain the liquid water condensed by the condenser coil.

14. A water purification system comprising:
a water supply valve;
a plurality of water tanks;
a vacuum chamber;
a condenser;
a compressor; and
a dispensing system;
wherein:
the water supply valve facilitates the entry of water into the water purification system;
the plurality of water tanks comprise a plurality of level sensors wherein said level sensors determine the volume of water being contained within the respective water tank;
the vacuum chamber comprises a vacuum pump wherein said vacuum pump reduces a pressure within the vacuum chamber; and
the dispensing system expels water from at least one of the plurality of water tanks.

15. The water purification system as claimed in claim 1 further comprising a tap water purification system wherein:
the tap water purification system is interposed between the water supply valve and the vacuum chamber; and
the water communicated from the water supply valve to the vacuum chamber is purified through the tap water purification system.

16. The water purification system, as claimed in claim 15 wherein the vacuum pump reduces the pressure of the vacuum chamber to between 80%-92% vacuum;
the vacuum chamber further comprises an evaporation tank wherein water that has been purified through the tap purification system is contained.

17. The water purification system as claimed in claim 16 wherein the compressor transfers heat to the water within the evaporation chamber to a temperature between 38°−55° C. wherein the water boils, producing steam.

18. The water purification system as claimed in claim 17 wherein the condenser comprises a condenser coil;
the steam condensing into purified liquid water within the condenser coil.

19. The water purification as claimed in claim 18 wherein the plurality of water tanks contains the purified liquid water condensed by the condenser coil.

20. A water purification system comprising:
a water supply valve wherein said water supply valve transfers water into the water purification system;
a tap water purification system wherein said tap water purification system purifies the water entered through the water supply valve;
a vacuum chamber wherein said vacuum chamber further comprises an evaporation tank and a vacuum pump;
the vacuum pump reducing a pressure within the vacuum chamber to between 80%-92% vacuum pressure;
the evaporation tank containing a volume of water purified by the tap water purification system;
a compressor wherein said compressor transfers heat to the purified water within the evaporation tank, causing the purified water to boil at a temperature between 38°-55° Celsius;
a condenser comprising a condenser coil wherein steam from the evaporation tank is condensed to liquid water; and
a plurality of water storage container wherein the liquid water from the condenser is contained.
